(19) United States
(12) Patent Application Publication
(10) Pub. No.: US 2011/0317106 A1
(43) Pub. Date: Dec. 29, 2011

(54) LIQUID CRYSTAL DISPLAY DEVICE, ELECTRONIC APPARATUS, AND METHOD OF MANUFACTURING LIQUID CRYSTAL DISPLAY DEVICE

(75) Inventor: Hiromi SAITO, Chino (JP)

(73) Assignee: SEIKO EPSON CORPORATION, Tokyo (JP)

(21) Appl. No.: 13/167,021

(22) Filed: Jun. 23, 2011

(30) Foreign Application Priority Data
Jun. 29, 2010 (JP) 2010-147242

(51) Int. Cl. G02F 1/1335; H01J 9/24

(52) U.S. Cl. 349/106; 445/24

(57) ABSTRACT

A liquid crystal display device includes a first substrate that is provided with a plurality of color material layers, a second substrate that is disposed opposite to the first substrate, and a liquid crystal layer that is disposed between the first substrate and the second substrate. The first substrate includes a gap adjustment layer that is formed on at least one of the color material layers and that is adapted to adjust a thickness of the liquid crystal layer between the first substrate corresponding to the at least one of the color material layers and the second substrate.

### BACKGROUND

The entire disclosure of Japanese Patent Application No. 2010-147242, filed Jun. 29, 2010 is expressly incorporated by reference herein.

1. Technical Field

The present invention relates to a liquid crystal display device, an electronic apparatus, and a method of manufacturing a liquid crystal display device.

2. Related Art

In the past, there has been known a liquid crystal display device provided with a multi-gap structure having liquid crystal layers, which are different in thickness and correspond to color filter layers of respective colors, in order for improving contrast. Such a liquid crystal display device is provided with a first substrate having a color filter layer, a second substrate disposed so as to be opposed to the first substrate, and a liquid crystal layer disposed between the first and second substrates. Further, the color filter layers are formed to have thicknesses different between the colors to thereby make the thicknesses of the liquid crystal layers disposed between the respective color filter layers and the second substrate different from each other, thus forming the multi-gap structure. The multi-gap structure is disclosed in, for example, Japanese Patent Publication Number JP-A-6-347802.

However, although in the liquid crystal display device described above the multi-gap structure is formed by making the thicknesses of the color filter layers different between the colors, it is required to perform color adjustment of the respective color filters simultaneously. There is a problem that it is difficult to achieve both the formation of the multi-gap structure and the adjustment of respective colors at the same time.

### SUMMARY

An advantage of some aspects of the invention is to provide a solution to at least a part of the problem described above. The invention can be embodied as the following forms or application examples.

### APPLICATION EXAMPLE 1

This application example of the invention is directed to a liquid crystal display device including a first substrate, a second substrate disposed to be opposed to the first substrate, and a liquid crystal layer disposed between the first substrate and the second substrate, wherein the first substrate includes a plurality of color material layers on which color adjustment is performed, and a gap adjustment layer disposed on at least one of the color material layers, and adapted to adjust a thickness of the liquid crystal layer between the first substrate corresponding to the at least one of the color material layers and the second substrate.

According to this configuration, the color adjustment is performed in each of the color material layers, and the thickness of the liquid crystal layer corresponding to each of the color material layers is adjusted in the gap adjustment layer. As described above, since the color adjustment function and the thickness adjustment function of the liquid crystal layer are performed separately, tone adjustment and the thickness adjustment of the liquid crystal layer can easily be performed.

### APPLICATION EXAMPLE 2

This application example of the invention is directed to the liquid crystal display device described above, which further includes an electrode layer formed on the gap adjustment layer, wherein a refractive index of the gap adjustment layer is higher than a refractive index of the color material layers, and is lower than a refractive index of the electrode layer.

According to this configuration, the gap adjustment layer, which is formed between the color material layers and the electrode layer, has an intermediate refractive index between the refractive index of the color material layers and the refractive index of the electrode layer. Further, when light is applied from the color material layer side toward the electrode layer side, the light proceeds from the color material layer toward the electrode layer via the gap adjustment layer. On this occasion, the light proceeds through the layers in which the refractive indexes gradually vary (in this case, the light proceeds in a direction in which the refractive indexes gradually increase). Therefore, when the light proceeds, the reflection of the light is reduced at the interfaces between the layers. Therefore, the transmittance can be improved. It should be noted that substantially the same action and advantages can be obtained when the light is applied from the electrode layer side toward the color material layer side (it should be noted that in this case the light proceeds in the direction in which the refractive indexes gradually decrease).

### APPLICATION EXAMPLE 3

This application example of the invention is directed to the liquid crystal display device described above, wherein the gap adjustment layer is a phase difference layer.

According to this configuration, the gap adjustment layer functions as the phase difference layer. In other words, since optical compensation is performed by the phase difference layer, contrast and view angle characteristics can be improved.

### APPLICATION EXAMPLE 4

This application example of the invention is directed to the liquid crystal display device described above, which further includes a phase difference layer formed on the gap adjustment layer.

According to this configuration, the color adjustment, the thickness adjustment of the liquid crystal layer, and phase adjustment can easily be performed.

### APPLICATION EXAMPLE 5

This application example of the invention is directed to a method of manufacturing a liquid crystal display device including: providing a first substrate, a second substrate disposed to be opposed to the first substrate, and a liquid crystal layer disposed between the first substrate and the second substrate, forming a plurality of color material layers, on which color adjustment is performed, on the first substrate, and forming, on at least one of the color material layers, a gap adjustment layer adapted to adjust a thickness of the liquid crystal layer between the first substrate corresponding to the at least one of the color material layers and the second substrate.

According to this configuration, the color adjustment is performed in each of the color material layers, and the thickness of the liquid crystal layer corresponding to each of the color material layers is adjusted in the gap adjustment layer. As described above, since the color adjustment function and the thickness adjustment function of the liquid crystal layer are performed separately, tone adjustment and the thickness adjustment of the liquid crystal layer can easily be performed.

### APPLICATION EXAMPLE 6

This application example of the invention is directed to an electronic apparatus including one of the liquid crystal display device according to the application example of the invention, and the liquid crystal display device manufactured by the method according to the application example of the invention.

According to the configuration of this application example of the invention, a high-grade electronic apparatus can be provided. In this case, as the electronic apparatus, there can be cited various types of electronic apparatuses such as a television set, a personal computer, a portable electronic apparatus in which the liquid crystal display device described above is installed.

### BRIEF DESCRIPTION OF THE DRAWINGS

The invention will be described with reference to the accompanying drawings, wherein like numbers reference like elements.

FIGS. 1A and 1B show a configuration of a liquid crystal display device according to a first embodiment of the invention. FIG. 1A is a perspective view of the liquid crystal display device. FIG. 1B is a partially enlarged plan view of the liquid crystal display device.

FIG. 2 is a cross-sectional view of a substantial part showing a configuration of a liquid crystal display device according to a first embodiment.

FIG. 3 is a perspective view showing a configuration of a droplet ejection device.

FIG. 4 is a cross-sectional view showing a configuration of a droplet ejection head.

FIGS. 5A through 5C are process charts showing a method of manufacturing a liquid crystal display device according to a first embodiment.

FIGS. 6A through 6C are process charts showing a method of manufacturing a liquid crystal display device according to a first embodiment.

FIG. 7 is a perspective view showing a configuration of an electronic apparatus.

FIG. 8 is a cross-sectional view of a substantial part showing a configuration of a liquid crystal display device according to a second embodiment.

### DESCRIPTION OF EXEMPLARY EMBODIMENTS

Hereinafter, first and second embodiments will be explained with reference to accompanying drawings. It should be noted that in the drawings used for an explanation, sizes and scales of structures in the drawings might be made different from actual structures in some cases in order for showing characteristic portions in an easy-to-understand manner. Further, constituents substantially identical to each other in the embodiments are shown with the same reference numerals in the drawings, and the detailed explanation therefore might be omitted in some cases.

### First Embodiment

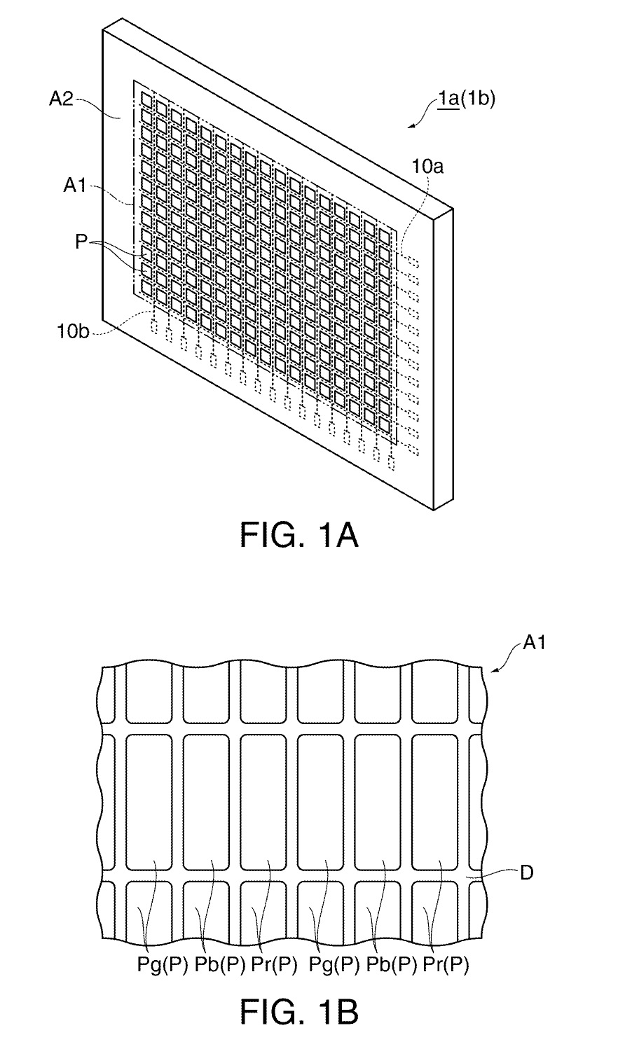

Firstly, the first embodiment will be explained. FIGS. 1A and 1B show a configuration of a liquid crystal display device 1a, wherein FIG. 1A is a perspective view, and FIG. 1B is a plan view magnifying the display area. As shown in FIG. 1A, the liquid crystal display device 1a has a roughly plate-like shape, and has a display area A1 on one surface thereof. A plurality of pixel areas P is arranged in a matrix in the display area A1. A frame A2 is formed on the periphery of the display area A1. Inside the liquid crystal display device 1a, there are disposed a plurality of scan lines 10a and a plurality of data lines 10b. The scan lines 10a are arranged in roughly parallel to each other. The data lines 10b are also arranged in roughly parallel to each other. The scan lines 10a and the data lines 10b are roughly orthogonal to (intersect with) each other. Further, each of the areas surrounded by the scan lines 10a and the data lines 10b forms the pixel area P.

The scan lines 10a and the data lines 10b are disposed over the display area A1 and the frame A2. In the frame A2, ends of the respective scan lines 10a are electrically connected to a scan line drive circuit (not shown) for supplying scan signals. Further, in the frame A2, ends of the respective data lines 10b are electrically connected to a data line drive circuit (not shown) for supplying image signals.

As shown in FIG. 1B, a plurality of pixel areas P is included in the display area A1. The pixel area P of the present embodiment includes a pixel area Pr for red display, a pixel area Pg for green display, and a pixel area Pb for blue display. Further, when the red light, the green light, and the blue light are emitted from the respective pixel areas Pr, Pg, and Pb toward a display side, the red light, the green light, and the blue light are viewed in a mixed state. Thus, one pixel of a full-color image is displayed. A light blocking area D is disposed between the pixel areas Pr, Pg, and Pb.

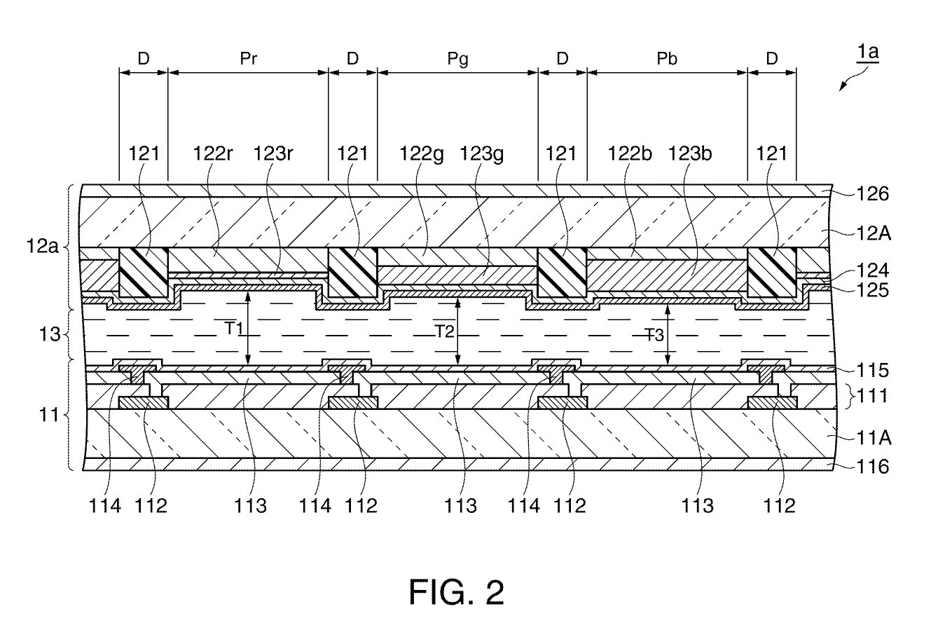

FIG. 2 is a cross-sectional view of a substantial part of the liquid crystal display device 1a according to the present embodiment. As shown in FIG. 2, the liquid crystal display device 1a is provided with a color filter substrate 12a as a first substrate, a device substrate 11 as a second substrate disposed facing the color filter substrate 12a, and a liquid crystal layer 13 disposed between the color filter substrate 12a and the device substrate 11.

The device substrate 11 is of an active matrix type, and has a transparent substrate 11A made of glass, quartz, or plastic as a base member. A device layer 111 is disposed on the transparent substrate 11A. The device layer 111 is provided with thin film transistors (TFTs) 112 as devices and with various wiring patterns such as the scan lines 10a and the data lines 10b as shown in FIG. 1A. It should be noted that the TFTs 112 and the various wiring patterns are disposed in the part corresponding to the light blocking area D where the light is blocked.

On the side of the liquid crystal layer 13 of the device layer 111, pixel electrodes 113, which have an island shape corresponding respectively to the pixel areas Pr, Pg, and Pb, are formed. The pixel electrodes 113 correspond to the TFTs 112 as a one-to-one relationship and are electrically connected to the corresponding TFTs 112. The TFTs 112 each perform switching of the image signal based on the scan signal to thereby supply the pixel electrode 113 with the image signal at a predetermined timing.

On the part of the device layer 111 overlapping the light blocking area D, a passivation film 114 that is made of an inorganic material such as silicon oxide is disposed. The passivation film 114 is formed so as to cover the peripheral portion of each of the pixel electrodes 113 in a ring-like manner and to straddle the peripheral portions of the respective pixel electrodes 113. A first oriented film 115 is disposed between the pixel electrodes 113 and the liquid crystal layer 13. The first oriented film 115 is a film made of polyimide on which an orientation process such as a rubbing process is performed. The first oriented film 115 controls an orientational state of the liquid crystal layer 13 in cooperation with a second oriented film 125 described later. Here, the orientation process is performed on the first oriented film 115 and the second oriented film 125 so as to provide the twisted nematic orientation (TN orientation) to the liquid crystal layer 13. Further, in the transparent substrate 11A, on the opposite side to the device layer 111, a first polarization plate 116 is disposed. The first polarization plate 116 has a property of transmitting linearly polarized light in a predetermined direction.

The color filter substrate 12a is configured with a transparent substrate 12A as a base substrate; a plurality of color material layers 122r, 122g, and 122b formed on the transparent substrate 12A for color adjustment; gap adjustment layers 123 (123r, 123g, and 123b) formed on the respective color material layers 122r, 122g, and 122b for adjusting the thicknesses of the liquid crystal layers 13 between the color filter substrate 12a and the device substrate 11 corresponding respectively to the color material layers 122r, 122g, and 122b; a common electrode 124 as an electrode layer formed on the gap adjustment layers 123; and the second oriented film 125 formed on the common electrode 124.

The transparent substrate 12A is a substrate having transparency made of glass, quartz, or plastic. Apart of the transparent substrate 12A overlapping the light blocking area D on the side of the liquid crystal layer 13 is provided with a partition 121. The partition 121 is provided with openings disposed at portions overlapping the pixel areas Pr, Pg, and Pb. Specifically, the partition 121 circularly surrounds each of the pixel areas Pr, Pg, and Pb. The partition 121 is made of acrylic resin including a light blocking material such as a black pigment. The partition 121 functions as a black matrix.

The color material layers 122r, 122g, and 122b are discretely disposed at the portions of the transparent substrate 12A overlapping the pixel areas Pr, Pg, and Pb, respectively, on the side of the liquid crystal layer 13. The color material layers 122r, 122g, and 122b are disposed inside the respective openings provided to the partition 121, and are therefore divided by the partition 121. The color material layers 122r, 122g, and 122b have properties of respectively transmitting red light, green light, and blue light and absorbing colored light of other wavelength range.

In the color material layers 122r, 122g, and 122b, the desired color adjustment is performed respectively. Specifically, each of the color material layers 122r, 122g, and 122b includes a coloring agent corresponding to a tone. The color material layers 122r, 122g, and 122b perform the color adjustment by varying the color optical density due to the type and the content of the coloring agent. It should be noted that as the coloring agents, various pigments and various dyes can be used. Therefore, the contents of the coloring agents included in the respective color material layers 122r, 122g, and 122b are different from each other. As a result, the thicknesses of the respective color material layers 122r, 122g, and 122b become different from each other in accordance with the contents of the coloring agent. In the present embodiment, the color material layers 122r, 122g, and 122b are formed by the following conditions: the red color material layer 122r has the largest layer thickness; the green color material layer 122g has the second largest layer thickness; and the blue color material layer 122b has the smallest layer thickness.

On the color material layers 122r, 122g, and 122b, the gap adjustment layers 123r, 123g, and 123b are, respectively, formed. The gap adjustment layers 123r, 123g, and 123b have a function of adjusting the thicknesses (T1 through T3) of the liquid crystal layers 13 corresponding respectively to the color material layers 122r, 122g, and 122b. The gap adjustment layers 123r, 123g, and 123b have the respective thicknesses different from each other. Thus, the multi-gap mechanism can be formed. In the present embodiment, the thickness of the gap adjustment layer 123r is the thinnest among the gap adjustment layers 123r, 123g, and 123b. The thickness of the gap adjustment layer 123b is the thickest among the gap adjustment layers 123r, 123g, and 123b. Further, regarding the total thicknesses of the color material layers 122 and the gap adjustment layers 123 of the respective colors, they are configured in the following conditions: the total thickness of the color material layer 122r and the gap adjustment layer 123r is the thinnest; and the total thickness of the color material layer 122b and the gap adjustment layer 123b is the thickest. As a result, the multi-gap structure is formed. The liquid crystal layer 13 in which the color material layer 122r is formed has the largest thickness T1 (the liquid crystal layer 13 is formed to have the largest thickness). The liquid crystal layer 13 in which the color material layer 122g is formed has the second largest thickness T2. The liquid crystal layer 13 in which the color material layer 122b is formed has the smallest thickness T3.

The gap adjustment layers 123r, 123g, and 123b each includes a resin material (binder resin). Thus, the gap adjustment layers 123 can be formed to have desired thicknesses. The resin material is not particularly limited, and any resin material can be used. However, it is preferable for the resin material to include a curable resin material. Thus, it is possible to make physical strength of the color material layers 122r, 122g, and 122b particularly superior, and to make durability of the color filter substrate 12a particularly superior. Further, in the case of including the curable resin material as the resin material, various thermoset resin and various light curing resin can be used as the curable resin material. In particular, acrylic resin having the multifunctional molecules polymerized with each other or epoxy resin is preferably used as the curable resin material. Further, as the curable resin material, the epoxy resin having the silyl acetate structure (SiOCOCH₃) and the epoxy structure is preferably used in particular in these resin materials. Thus, the droplet ejection using the inkjet method can preferably be performed, and at the same time, the adhesiveness with the color material layers 122r, 122g, and 122b and the transparent substrate 12A can be enhanced.

The common electrode 124 is formed on the gap adjustment layers 123r, 123g, and 123b and the partition 121. The common electrode 124 is formed of a transparent electrode material (ITO). Further, the second oriented film 125 is formed on the common electrode 124. Further, on the opposite side of the transparent substrate 12A to the color material layers 122, a second polarization plate (a polarization layer) 126 is disposed. The second polarization plate 126 has a property of transmitting linearly polarized light. Here, the transmission axis of the second polarization plate 126 is at the angle of roughly 90° with the transmission axis of the first polarization plate 116. The common electrode 124, the second oriented film 125, and the second polarization plate 126 are all disposed on roughly the entire surface corresponding to the pixel areas Pr, Pg, and Pb.

Further, as the color filter substrate 12a, it is preferable that the refractive index of the gap adjustment layer 123 is higher than the refractive index of the color material layer 122. At the same time, it is preferable that the refractive index of the gap adjustment layer 123 is lower than the refractive index of the common electrode 124. Specifically, the refractive index of the color material layer 122 is set to approximately 1.5. The refractive index of the common electrode 124 is set to approximately 1.9. The refractive index of the gap adjustment layer 123 is set to approximately 1.7. In other words, the refractive index of the gap adjustment layer 123 is set so as to have a value between the refractive index of the color material layer 122 and the refractive index of the common electrode 124. As described above, since the gap adjustment layer 123 having the intermediate refractive index is formed between the color material layer 122 and the common electrode 124, if light is transmitted through the color material layer 122, the gap adjustment layer 123, and the common electrode 124, the reflection of the light on the interfaces between the respective layers is reduced. Thus, the transmittance can be enhanced.

The liquid crystal layer 13 is formed of a liquid crystal material having a birefringent property. Here, the orientational state of the liquid crystal layer 13 is set to the TN orientation. The liquid crystal layer 13 is arranged to develop the birefringent property in the condition in which no electrical field is applied. If the electrical field is applied to the liquid crystal layer 13, the direction of the director of the liquid crystal molecules becomes roughly parallel to the electrical field direction. As a result, the liquid crystal layer 13 stops developing the birefringent property.

### Method of Manufacturing Liquid Crystal Display Device

Then, a method of manufacturing the liquid crystal display device will be explained. It should be noted that since a droplet ejection device for ejecting the functional fluid as droplets to thereby form the pattern is used in the manufacture of the color filter substrate of the liquid crystal display device, the droplet ejection device will firstly be explained in advance of the explanation of the manufacturing method of the liquid crystal display device.

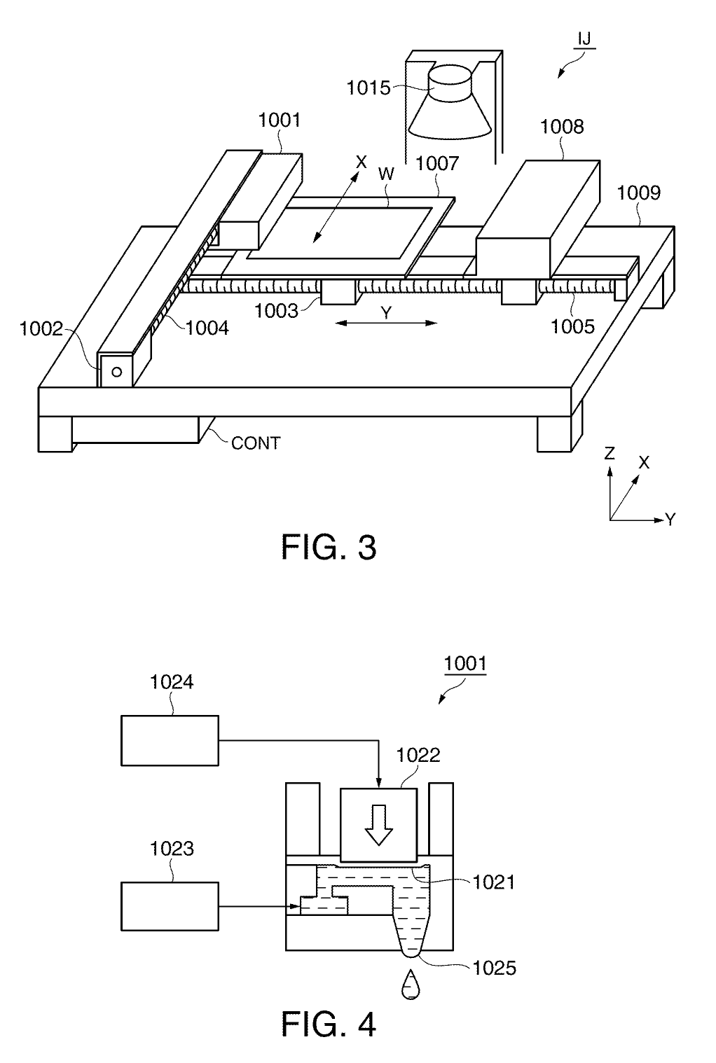

FIG. 3 is a perspective view showing a configuration of a droplet ejection device IJ. The droplet ejection device IJ is provided with a droplet ejection head 1001, an X-axis direction driving shaft 1004, a Y-axis direction guiding shaft 1005, a controller CONT, a stage 1007, a cleaning mechanism 1008, a base 1009, and a heater 1015.

The stage 1007 is for supporting a work W coated with the functional fluid, and is provided with a fixing mechanism, not shown, for fixing the work W at a reference position.

The droplet ejection head 1001 is a multiple-nozzle type head provided with a plurality of ejection nozzles. A longitudinal direction of the droplet ejection head 1001 coincides with the X-axis direction. The plurality of ejection nozzles is disposed on the lower surface of the droplet ejection head 1001 at constant intervals. Further, it is arranged to eject the functional fluid from the ejection nozzles of the droplet ejection head 1001 as droplets to the work W supported by the stage 1007 to thereby apply the functional fluid to the surface of the work W.

An X-axis direction driving motor 1002 is coupled to the X-axis direction driving shaft 1004. The X-axis direction driving motor 1002 is composed of a stepping motor and rotates the X-axis direction driving shaft 1004 when a drive signal of the X-axis direction is supplied from the controller CONT. When the X-axis direction driving shaft 1004 rotates, the droplet ejection head 1001 moves in the X-axis direction.

The Y-axis direction guiding shaft 1005 is fixed to the base 1009 so as not to move relatively thereto. The stage 1007 is provided with a Y-axis direction driving motor 1003. The Y-axis direction driving motor 1003 is a stepping motor and moves the stage 1007 in the Y-axis direction when a drive signal of the Y-axis direction is supplied from the controller CONT.

The controller CONT supplies the droplet ejection head 1001 with voltages for controlling ejection of droplets. Further, the controller CONT supplies the X-axis direction driving motor 1002 with a drive pulse signal for controlling the movement of the droplet ejection head 1001 in the X-axis direction. The controller CONT also supplies the Y-axis direction driving motor 1003 with a drive pulse signal for controlling the movement of the stage 1007 in the Y-axis direction.

The cleaning mechanism 1008 is for cleaning the droplet ejection head 1001. The cleaning mechanism 1008 is provided with a Y-axis direction driving motor not shown in the drawings. While driving the Y-axis direction driving motor, the cleaning mechanism 1008 moves along the Y-axis direction guiding shaft 1005. The movement of the cleaning mechanism 1008 is also controlled by the controller CONT.

The heater 1015 here performs a heat process on the work W using a lamp annealing process and evaporates the solvent included in the functional fluid disposed on the work W to dry the work W. The controller CONT also controls powering on and off of the heater 1015.

The droplet ejection device IJ ejects droplets to the work W from the plurality of ejection nozzles, which are arranged in the lower surface of the droplet ejection head 1001 in the X-axis direction, while scanning the droplet ejection head 1001 and the stage 1007 supporting the work W relatively to each other.

FIG. 4 is a cross-sectional view of the droplet ejection head 1001 for explaining the principle of ejection of the functional fluid using the piezoelectric method. In FIG. 4, piezoelectric elements 1022 are disposed adjacent to a fluid chamber 1021 that contains the functional fluid. The functional fluid is supplied to the fluid chamber 1021 via a fluid material supply system 1023 including a material tank that stores the functional fluid. The piezoelectric element 1022 is connected to a drive circuit 1024. The piezoelectric element 1022 is distorted by applying voltage to the piezoelectric element 1022 via the drive circuit 1024. Thus, the fluid chamber 1021 is also distorted to thereby eject the functional fluid from the ejection nozzle 1025. In this case, the amount of the distortion of the piezoelectric element 1022 is controlled by changing the value of the applied voltage. Further, the speed of the distortion of the piezoelectric element 1022 is controlled by changing the frequency of the applied voltage. A droplet ejection with the piezoelectric method has an advantage that a harmful influence is hardly exerted on the material compositions since the materials are not heated.

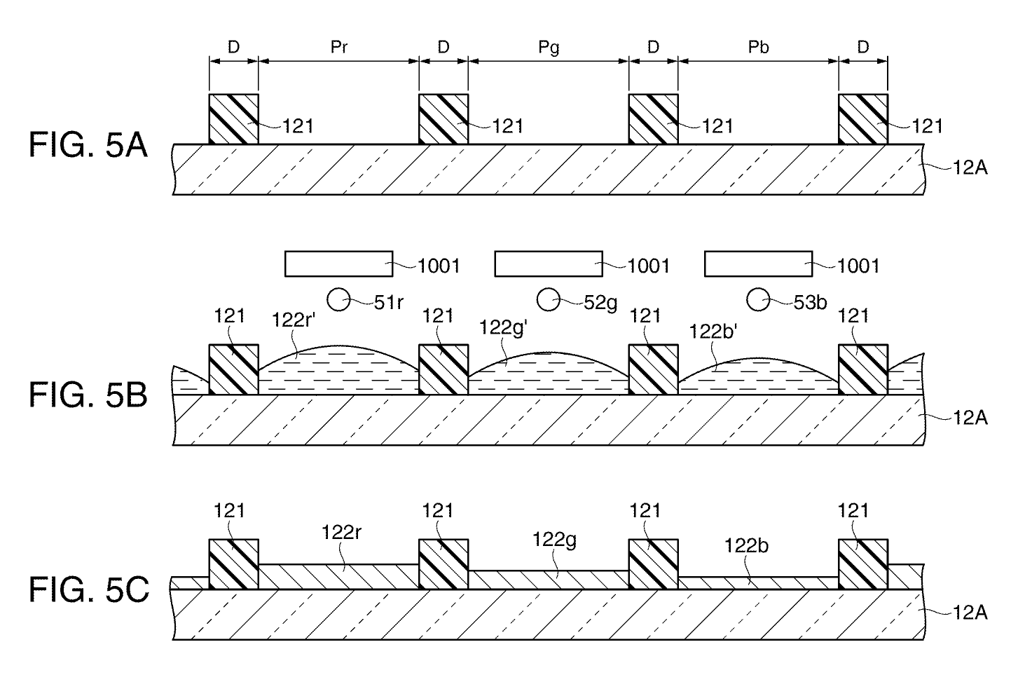

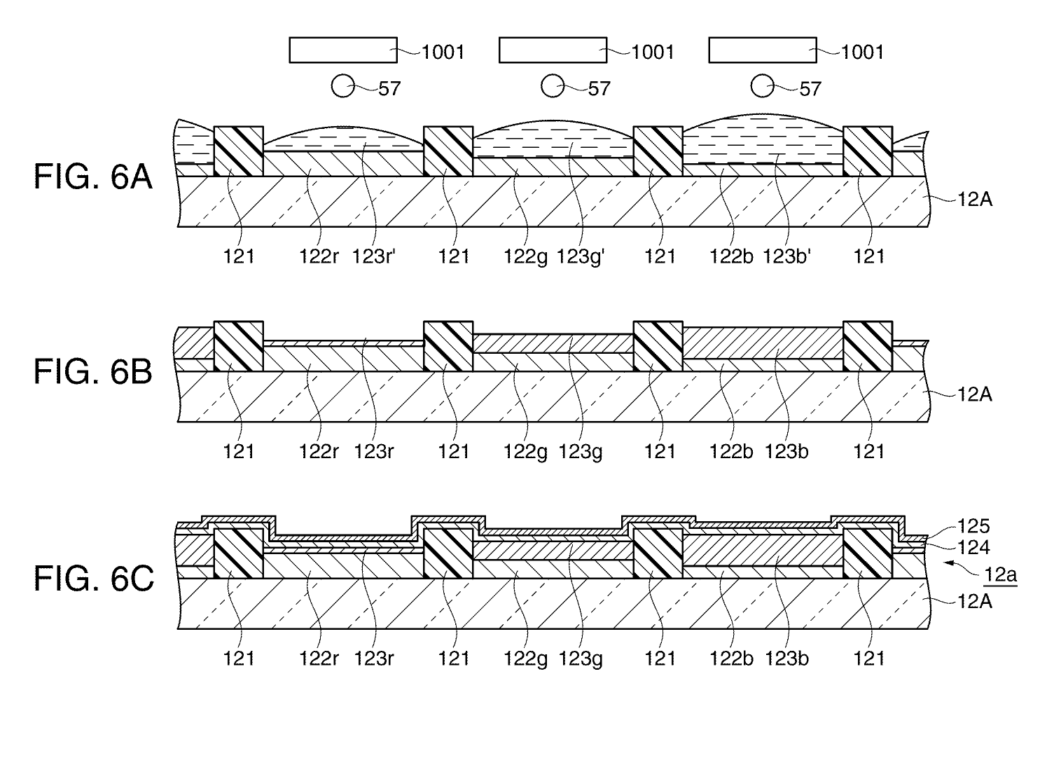

Returning to the explanation of the manufacturing method of the liquid crystal display device, the explanation will be presented with reference to the drawings. FIGS. 5A through 5C and 6A through 6C are process charts showing the manufacturing method of the color filter substrate 12a of the liquid crystal display device 1a. The manufacturing method of the liquid crystal display device 1a in the present embodiment is a manufacturing method of the liquid crystal display device 1a provided with the color filter substrate 12a as the first substrate, the device substrate 11 as the second substrate disposed so as to face the color filter substrate 12a, and the liquid crystal layer 13 disposed between the color filter substrate 12a and the device substrate 11. The manufacturing method for the liquid crystal display device la includes a color material layer formation process for forming a plurality of color material layers 122r, 122g, and 122b, on which the color adjustment is performed, on the color filter substrate 12a, and a gap adjustment layer formation process for forming the gap adjustment layers 123r, 123g, and 123b for adjusting the thicknesses of the liquid crystal layer 13 between the color filter substrate 12a and the device substrate 11 corresponding respectively to the gap adjustment layers 123r, 123g, and 123b on the color material layers 122r, 122g, and 122b.

Firstly, as shown in FIG. 5A, the partition 121 is formed on the transparent substrate 12A. Specifically, the partition 121 is formed by depositing a resin material film on the transparent substrate 12A. Then the openings are formed at the portions of the film overlapping the pixel areas Pr, Pg, and Pb.

Subsequently, in the color material layer formation process, as shown in FIG. 5B, the functional fluids 122r′, 122g′, and 122b respectively including the materials of the color material layers 122r, 122g, and 122b are formed by ejecting droplets 51r, 52g, and 53b from the droplet ejection head 1001 of the droplet ejection device IJ toward the respective areas zoned by the partition 121 to thereby apply the functional fluids 122r′, 122g′, and 122b′ to the respective portions surrounded by the partition 121. On this occasion, the color adjustment is performed. Specifically, the color adjustment of each of the colors is performed by attaching the functional fluid including the coloring agent including the content of the pigment corresponding to the color. As a result, the amount of application is different between the colors. In the present embodiment, the amount of application increases in the order of the functional fluids 122b′, 122g′, and 122r′.

Subsequently, the functional fluids 122r′, 122g′, and 122b′ thus applied are dried or burnt to thereby be solidified. Thus, the color material layers 122r, 122g, and 122b are formed as shown in FIG. 5C. In the present embodiment, the layer thickness increases in the order of the color material layers 122b, 122g, and 122r.

Subsequently, in the gap adjustment layer formation process, as shown in FIG. 6A, the functional fluids 123r′, 123g′, and 123b′ including the material of the gap adjustment layer 123 are formed by ejecting droplets 57 from the droplet ejection head 1001 of the droplet ejection device IJ toward the respective color material layers 122r, 122g, and 122b to thereby apply the functional fluids 123r′, 123g′, and 123b′ to the respective surfaces of the color material layers 122r, 122g, and 122b. On this occasion, the thickness adjustment of the liquid crystal layer 13 corresponding to each of the color material layers 122r, 122g, and 122b is performed. Specifically, the adjustment of the amount of application of the functional fluid corresponding to each of the colors is performed. As a result, the amount of application of the functional fluid 123′ is different between the colors. In the present embodiment, the droplets 57 are ejected so that the amount of application increases in the order of the functional fluids 123r′, 123g′, and 123b′.

Subsequently, the functional fluids 123r′, 123g′, and 123b′ thus applied are dried or burnt to thereby be solidified. Thus, as shown in FIG. 6B, the gap adjustment layers 123r, 123g, and 123b are formed respectively on the color material layers 122r, 122g, and 122b. In the present embodiment, the thicknesses of the gap adjustment layers 123r, 123g, and 123b are set so as to increase in this order. The thicknesses of the gap adjustment layers 123r, 123g, and 123b corresponding respectively to the color material layers 122r, 122g, and 122b are arranged so that the total thickness of the color material layer 122r and the gap adjustment layer 123r is the thinnest; and the total thickness of the color material layer 122b and the gap adjustment layer 123b is the thickest. Therefore, as a result, the thickness of the liquid crystal layer 13 corresponding to the color material layer 122r is the thickest; and the thickness of the liquid crystal layer 13 corresponding to the color material layer 122b is the thinnest.

Subsequently, as shown in FIG. 6C, the transparent electrically conductive material such as ITO is deposited on the gap adjustment layers 123r, 123g, and 123b and the partition 121 to thereby form the common electrode 124. Then, the second oriented film 125 is formed on the common electrode 124. Thus, the color filter substrate 12a without the second polarization plate 126 is formed.

Subsequently, the device substrate 11 is formed separately from the formation of the color filter substrate 12a described above. Specifically, the TFTs 112 and the various wiring patterns are formed on the transparent substrate 11A to thereby form the device layer 111. Then, the pixel electrodes 113 each having an island shape are formed on the device layer 111. Subsequently, the passivation film 114 is formed continuously on the peripheral portions of the pixel electrodes 113 and between the pixel electrodes 113. For example, an inorganic material (such as a silicon oxide) film is deposited on roughly the entire surface of the transparent substrate 11A. Then, the passivation film 114 can be obtained by patterning the inorganic material film so as to expose the portions (central portions) overlapping the respective pixel areas Pr, Pg, and Pb in the pixel electrodes 113. Subsequently, the first oriented film 115 is formed on roughly the entire surface of the transparent substrate 11A. The first oriented film 115 covers the pixel electrodes 113 and the passivation film 114. The device substrate 11 can be formed by appropriately using the formation materials and the formation method known to the public.

Subsequently, the device substrate 11 and the color filter substrate 12a are disposed opposite to each other so that the pixel electrodes 113 and the common electrode 124 are located inside. Then, the peripheral portion of the device substrate 11 and the peripheral portion of the color filter substrate 12a are bonded to each other while performing the alignment between the device substrate 11 and the color filter substrate 12a. At the same time, the liquid crystal material is encapsulated between the device substrate 11 and the color filter substrate 12a. And then the liquid crystal layer 13 is sealed. Further, the first polarization plate 116 is attached to the outer side of the transparent substrate 11A, and the second polarization plate 126 is attached to the outer side of the transparent substrate 12A. And thus the liquid crystal display device 1a provided with the multi-gap structure can be obtained.

### Configuration of Electronic Apparatus

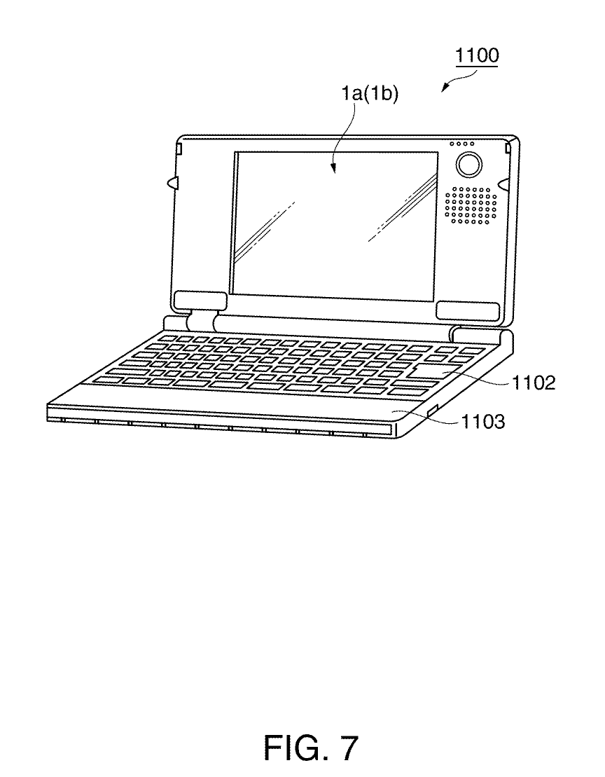

Then, a configuration of an electronic apparatus will be explained. It should be noted that in the present embodiment, a configuration of a mobile personal computer 1100 as the electronic apparatus will be explained. FIG. 7 is a perspective view showing the configuration of the mobile personal computer 1100 as the electronic apparatus. The mobile personal computer 1100 is provided with the liquid crystal display device 1a and a main body section 1103 having a keyboard 1102. It should be noted that the electronic apparatus described above is presented only for the purpose of exemplification of the electronic apparatus according to the invention. Therefore, the above electronic apparatus does not limit the scope of the invention. For example, the liquid crystal display device 1a can also be applied to a cellular phone, a portable audio device, a personal digital assistant (PDA), and so on as other electronic apparatuses.

Therefore, according to the first embodiment described above, the following advantages can be obtained.

1. In each of the color material layers 122r, 122g, and 122b, the adjustment of the color is performed. The thickness of each of the color material layers 122r, 122g, and 122b is set based on the color adjustment. And the thickness adjustment of the liquid crystal layer 13 corresponding to the color material layers 122r, 122g, and 122b is performed in the gap adjustment layers 123r, 123g, and 123b. In other words, by separating the color adjustment function and the thickness adjustment function of the liquid crystal layer from each other, the desired tint (color) adjustment and the formation of the multi-gap structure can be performed easily.

2. The gap adjustment layers 123 having the intermediate refractive index between the refractive index of the color material layer 122 and the refractive index of the common electrode 124 are disposed between the respective color material layers 122 and the common electrode 124. Thus, the difference in refractive index between the layers is reduced and thus the reflection of the light on the interfaces between the layers is reduced. Therefore, the transmittance can be improved.

### Second Embodiment

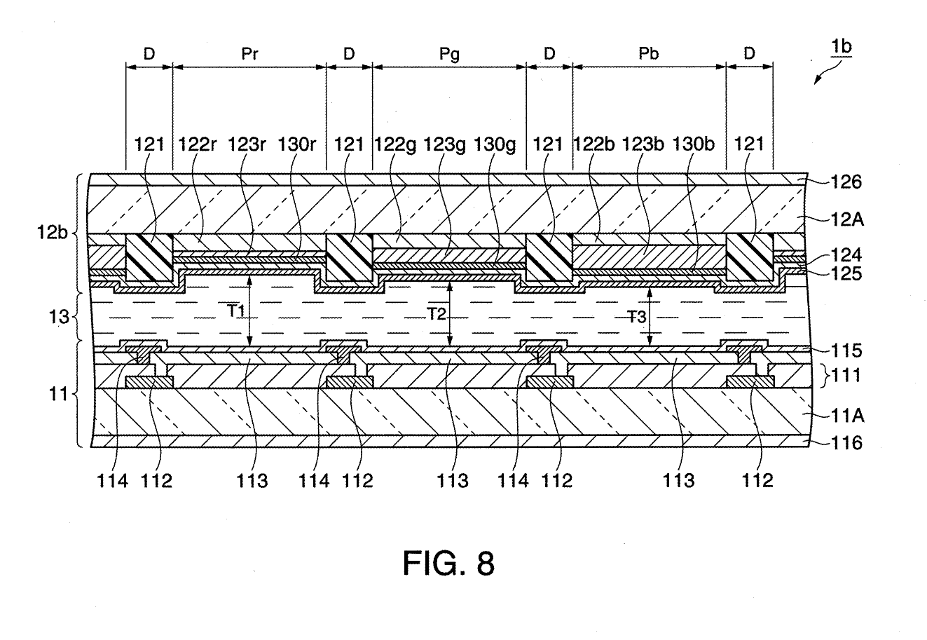

Then, a second embodiment will be explained. FIG. 8 is a cross-sectional view of a substantial part showing a configuration of a liquid crystal device 1b. In the second embodiment, since the basic configuration of the liquid crystal display device 1b and the configurations of the liquid crystal layer 13, the device substrate 11, and an electronic apparatus are substantially the same as the first embodiment. Therefore, explanations for them will be omitted (see FIGS. 1A and 1B, FIGS. 2, and 7). A configuration of a color filter substrate 12b particularly different from that of the first embodiment will mainly be explained. It should be noted that the members similar to those of the first embodiment are denoted with the same reference numerals.

The color filter substrate 12b of the liquid crystal display device 1b is provided with a transparent substrate 12A as abase substrate, a plurality of color material layers 122r, 122g, and 122b formed on the transparent substrate 12A, gap adjustment layers 123r, 123g, and 123b formed on the respective color material layers 122r, 122g, and 122b and adjusted in a thickness of a liquid crystal layer 13 corresponding to the color material layers 122r, 122g, and 122b, phase difference layers 130r, 130g, and 130b formed on the respective gap adjustment layers 123r, 123g, and 123b, a common electrode 124 as an electrode layer formed on the phase difference layers 130r, 130g, and 130b, and a second oriented film 125 formed on the common electrode 124. It should be noted that the basic configuration of the transparent substrate 12A, the color material layers 122r, 122g, and 122b, the gap adjustment layers 123r, 123g, and 123b, the common electrode 124, and the second oriented film 125 is substantially the same as the first embodiment. Therefore, an explanation for them will be omitted.

The phase difference layers 130r, 130g, and 130b are for optically compensating (canceling out the phase difference) distortion of light transmitted through the liquid crystal layer 13. Thus, enhancement of a view angle and improvement of image quality can be achieved. The phase difference layers 130r, 130g, and 130b use a macromolecular precursor having self-orientation. Further, a birefringent property and a thickness of each of the phase difference layers 130r, 130g, and 130b are determined based on a polarization state of light previously transmitted through each of the phase difference layers 130r, 130g, and 130b. Then, the type of the macromolecular precursor included in each of the phase difference layers 130r, 130g, and 130b is selected based on the birefringent property thus determined. Then, by polymerizing the macromolecular precursor, the phase difference layers 130r, 130g, and 130b are formed.

Further, regarding total thicknesses of the color material layers 122, the gap adjustment layers 123, and the phase difference layers 130 of the respective colors, the total thickness of the color material layer 122r, the gap adjustment layer 123r, and the phase difference layer 130r is the thinnest; and the total thickness of the color material layer 122b, the gap adjustment layer 123b, and the phase difference layer 130b is the thickest. As a result, the multi-gap structure is formed with the following conditions: the liquid crystal layer 13 corresponding to the color material layer 122r has the largest thickness T1; the liquid crystal layer 13 corresponding to the color material layer 122g has the second largest thickness T2; and the liquid crystal layer 13 corresponding to the color material layer 122b has the smallest thickness T3.

Therefore, according to the second embodiment described above, the following advantages can be obtained in addition to the advantages of the first embodiment.

The phase difference layers 130r, 130g, and 130b are further formed in addition to the color material layers 122r, 122g, and 122b and the gap adjustment layers 123r, 123g, and 123b. Thus, it is possible to perform the phase difference compensation for each of the pixel areas Pr, Pg, and Pb. Further, contrast and view angle characteristics can be improved.

It should be noted that the present invention is not limited to the embodiments described above. But the following modified examples can also be included in the present invention.

### FIRST MODIFIED EXAMPLE

Although in the embodiments described above the explanation is presented citing the three types of color material layers 122r, 122g, and 122b as an example, the color material layers 122r, 122g, and 122b are not limited thereto. It is also possible that the color material layer 122 can be a single type of color material layer, two types, or four or more types of color material layers. Also in such a case, substantially the same advantages as the embodiments described above can be obtained.

### SECOND MODIFIED EXAMPLE

The liquid crystal layer 13 explained in the embodiments described above can be the layer provided with other orientations than the TN orientation such as the VA orientation or the layer driven by the lateral electrical field. In the case of changing the orientation of the liquid crystal layer or the drive method, it is enough to change an electrode arrangement, characteristics of the oriented film, and characteristics of the polarization plate as well if necessary. Further, besides the transmissive liquid crystal display device, a reflective or a semi-transmissive/semi-reflective liquid crystal display device can also be adopted. According also to this configuration, substantially the same advantages as the embodiments can be obtained.

### THIRD MODIFIED EXAMPLE

Although in the liquid crystal display device la according to the first embodiment, the color material layers 122 are formed on the transparent substrate 12A of the color filter substrate 12a, the configuration is not limited thereto. The color material layers 122 can also be disposed on the side of the device substrate 11. In this case, the TFTs 112 can be disposed on the transparent substrate 11A. The color material layers 122 can be disposed on the TFTs 112. The gap adjustment layers 123 can be disposed on the color material layers 122. And the pixel electrodes 113 as the electrode layer can be disposed on the gap adjustment layers 123. In other words, the liquid crystal display device having a color filter on array (COA) configuration can also be adopted. Further, it is arranged that the refractive index of the gap adjustment layer 123 is higher than the refractive index of the color material layer 122. At the same time, the refractive index of the gap adjustment layer 123 is lower than the refractive index of the pixel electrode 113. According also to this configuration, substantially the same advantages as the embodiments described above can be obtained. It should be noted that in the liquid crystal display device 1b according to the second embodiment, substantially the same configuration described above can also be adopted. In this case, the TFTs 112 can be disposed on the transparent substrate 11A. The color material layers 122 can be disposed on the TFTs 112. The gap adjustment layers 123 can be disposed on the color material layers 122. The phase difference layers 130 can be disposed on the gap adjustment layers 123. The pixel electrodes 113 as the electrode layer can be disposed on the phase difference layers 130. According also to this configuration, substantially the same advantages as the embodiments described above can be obtained.

### FOURTH MODIFIED EXAMPLE

Although in the second embodiment the phase difference layers 130 are disposed on the gap adjustment layers 123, the invention is not limited to this configuration. It is also possible to make the gap adjustment layers 123 function as the phase difference layers 130. In other words, it is also possible to perform optical compensation by the color material layers 122 and the gap adjustment layers 123. According also to this configuration, substantially the same advantages as in the embodiments described above can be obtained.

What is claimed is:

1. A liquid crystal display device comprising:
a first substrate;
a second substrate that is disposed opposite to the first substrate; and
a liquid crystal layer that is disposed between the first substrate and the second substrate, wherein
the first substrate includes
a plurality of color material layers on which color adjustment is performed, and
a gap adjustment layer that is disposed on at least one of the color material layers and that is adapted to adjust a thickness of the liquid crystal layer between the first substrate corresponding to the at least one of the color material layers and the second substrate.

2. The liquid crystal display device according to claim 1, further comprising:
an electrode layer that is formed on the gap adjustment layer, wherein
a refractive index of the gap adjustment layer is higher than a refractive index of the color material layers, and the refractive index of the gap adjustment layer is lower than a refractive index of the electrode layer.

3. The liquid crystal display device according to claim 1, wherein
the gap adjustment layer is a phase difference layer in which optical compensation is performed.

4. The liquid crystal display device according to claim 1, further comprising:
a phase difference layer that is formed on the gap adjustment layer, wherein
the phase difference layer optically compensates distortion of light that is transmitted through the liquid crystal layer.

5. A method of manufacturing a liquid crystal display device, comprising:
providing a first substrate, a second substrate that is disposed opposite to the first substrate, and a liquid crystal layer that is disposed between the first substrate and the second substrate;
forming a plurality of color material layers, on which color adjustment is performed, on the first substrate; and
forming, on at least one of the color material layers, a gap adjustment layer that is adapted to adjust a thickness of the liquid crystal layer between the first substrate corresponding to the at least one of the color material layers and the second substrate.

6. An electronic apparatus comprising:
the liquid crystal display device according to claim 1.

7. An electronic apparatus comprising:
the liquid crystal display device according to claim 2.

8. An electronic apparatus comprising:
the liquid crystal display device according to claim 3.

9. An electronic apparatus comprising:
the liquid crystal display device according to claim 4.

10. An electronic apparatus comprising:
the liquid crystal display device manufactured by the method according to claim 5.

11. A liquid crystal display device comprising:
a first substrate;
a second substrate that is disposed opposite to the first substrate; and
a liquid crystal layer disposed between the first substrate and the second substrate, wherein
the first substrate includes
first, second and third color material layers on which color adjustment is performed and thicknesses of the first, second and third color material layers are different each other, and
first, second and third gap adjustment layers that are disposed on the first, second and third color material layers, respectively, and the first, second and third gap adjustment layers adjust thicknesses of the liquid crystal layer between the first substrate in which the first, second and third color material layers are formed, respectively, and the second substrate.

12. The liquid crystal display device according to claim 11, further comprising:
partitions that divide each of the first, second and third color material layers and each of the first, second and third gap adjustment layers into an island shape, wherein
each of the first, second and third color material layers and each of the first, second and third gap adjustment layers are surrounded by the partitions, and
the first color material layer and the first gap adjustment layer correspond to a first color pixel area, the second color material layer and the second gap adjustment layer correspond to a second color pixel area that is a different color from the first color pixel area, and the third color material layer and the third gap adjustment layer correspond to a third color pixel area that is a different color from the first and second color pixel areas.

13. The liquid crystal display device according to claim 12, wherein
a first thickness of the liquid crystal layer between the first and second substrates in the first color pixel area is thicker than a second thickness of the liquid crystal layer between the first and second substrates in the second color pixel area, and
the second thickness of the liquid crystal layer is thicker than a third thickness of the liquid crystal layer between the first and second substrates in the third color pixel area.
